(19) United States
(12) Patent Application Publication
(10) Pub. No.: US 2024/0189695 A1
(43) Pub. Date: Jun. 13, 2024

(54) ISOKINETIC REHABILITATION MACHINE PROVIDED WITH LIGHT IRRADIATING PROPRIOCEPTIVE STIMULATION MEANS

(71) Applicant: PANDHORA S.R.L., Napoli (IT)

(72) Inventor: Stefano Troncone, Salerno (IT)

(21) Appl. No.: 18/286,714

(22) PCT Filed: Apr. 22, 2022
(86) PCT No.: PCT/IB2022/053776

§ 371 Date: Oct. 12, 2023

(30) Foreign Application Priority Data
Apr. 27, 2021 (IT) 102021000010562

(51) Int. Cl. A63B 71/06; A63B 21/00; A63B 21/002; A63B 24/00

(52) U.S. Cl. CPC A63B 71/0622; A63B 21/00178; A63B 21/00181; A63B 21/002; A63B 24/0062; A63B 24/0087; A63B 2071/0647; A63B 2213/002; A63B 2225/02; A63B 2225/64; A63B 2225/74

(57) ABSTRACT

Isokinetic rehabilitation machine provided with light irradiating proprioceptive stimulation, comprising: a support (1), on which at least a dynamometer (2) is installed, which is connected to an arm (4) provided with gripping elements (41) for moving a patient higher or lower limbs; at least an infrared light source (5) integral with said support (1), directed so to illuminate at least a muscle group moved by means of said arm (4); a data processing and control unit (6), configured to control said at least one light source (5) and said dynamometer (2), characterized in that said data processing and control unit (6) is configured to control an adjusting cycle of the intensity of said at least one infrared light source (5) as a function of the movement cycle imposed by said dynamometer (2).

### BACKGROUND OF THE INVENTION

### 1. Field of the Invention

The present invention relates to a machine for isokinetic rehabilitation. In particular, the present invention relates to an isokinetic rehabilitation machine provided with light irradiating proprioceptive stimulation means.

The present invention provides an isokinetic machine allowing to carry out a combined exercise with physical and proprioceptive stimuli so to speed up and maximize the rehabilitation process.

### 2. Technical Field

The isokinetic exercise, or the exercise carried out at isovelocity, is a dynamic muscle exercise carried out at constant speed while using suitable tools.

Since the 70′ the isokinetic method has become an integrating part of many rehabilitation protocols and estimation protocols in medical rehabilitation, sports medicine and legal medicine.

The isokinetic machines are very sophisticated equipment provided with a dynamometer, controlled by a software, which allows to keep the movement angular velocity constant and so the force developed by the muscle; the software allows also to adjust and control in real time the exercise carried out by the patient, as well as to store and analyze data detected during workout sessions.

It is to be specified that the term dynamometer indicates herein an actuator configured to move a patient limb and provided with means for measuring the force applied, the position and speed.

By means of the isokinetic equipment it is possible to evaluate the force of a muscle. This is particularly useful in the rehabilitation step, for example in case of quadriceps muscle after an anterior cruciate ligament reconstruction surgery, since it allows a rehabilitation protocol to be built in which, since the very first post-surgery steps, the isokinetic muscle exercise is associated to traditional physiotherapy. It is possible to monitor the work by adapting it from time to time to the patient needs, to check the progress and finally to carry out an evaluation by comparing the limb subjected to surgery to the healthy counter lateral one. The patient will be able to work for muscle strengthening in a totally safe way since the isokinetic exercise is carried out in discharge mode, without leaning the limb subjected to surgery on the floor, and above all the resistance opposed by the machine to the active muscle effort does not weigh down on the joint subjected to surgery since it is adapted to the same force exerted by the patient, without imposing an overload determined a priori.

In case the patient does not have the force sufficient to raise the limb, the movement can be imposed by the isokinetic device which, instead of hindering the movement, helps it, thus allowing to carry out complete and controlled movements, even without the muscle force needed.

Many types of muscle contraction exist, which can be obtained thanks to this kind of machine, some of which cannot be realized with common gym tools, and which are however contraindicated in the starting steps of the rehabilitation since they would be carried out by overloading the joint.

The isokinetic exercise can be used to work on the muscles of any joint: the knee extensor and flexor muscles, the shoulder rotator cuff muscles, the ankle stabilizing muscles.

The isokinetic working mode can be widely applied in the rehabilitation field as muscle reconditioning after orthopedic surgery, but also in the sport field as valid aid for trainings since it allows to optimize the muscle effort and so to develop the force in excellent way. It is also used in legal medicine since it allows to carry out an exact and above all documentable muscle functionality evaluation.

In some embodiments known at the state of the art, in order to increase the patient proprioceptive stimulation, monitors are associated to the isokinetic machines, which monitors are in a position visible by the patient and reproduce the patient movements in virtual reality. In this way, the therapy becomes even more efficient. Anyway, the patient is not physically stimulated in any way, but only in a visual way.

At the state of the art, there are also known rehabilitation techniques based on the usage of infrared radiation. The main effect of the infrared radiation is a thermal action, for this reason such therapy is used to prepare the patient for massage or kinesitherapy. The therapeutical effects of the infrared radiation are mainly due to the increase in temperature in the irradiated tissues and are represented by muscle relaxation, analgesia, trophic effect. This occurs because the infrared radiation allows to heat at depth, thus determining a dilatation of the vasculature provided in the treated area, with an increase in the local blood circulation, and, as a consequence, a greater oxygenation of the tissues, which regenerate. Furthermore, it is added a stimulating effect on the nerve endings, which reduces pain and relaxes muscles.

At the state of the art, there are known many equipment which allow to carry out rehabilitation by means of isokinetic machines. Some examples are described in documents US2006/079817, U.S. Pat. No. 5,403,251 and US2016107025.

Anyway, all the embodiments known at the state of the are limited since they do not optimize the patient proprioceptive stimulation.

In particular, none of the systems known at the state of the art comprises an infrared irradiating system acting on the muscles during movement in a combined way with the isokinetic rehabilitation treatment.

### SUMMARY OF THE INVENTION

Aim of the present invention is to provide an isokinetic machine, which overcomes the limits linked to the embodiments known at the state of the art. In particular, the present invention provides an isokinetic machine which optimizes the patient proprioceptive stimulation; more in particular, the present invention provides an isokinetic machine comprising an infrared irradiating system configured to act on the muscles during the movement in a combined way with the isokinetic rehabilitation treatment.

The invention realizes the prefixed aims since it is an isokinetic rehabilitation machine provided with light irradiating proprioceptive stimulation, comprising: a support (1), on which at least a dynamometer (2) is installed, which is connected to an arm (4) provided with gripping elements (41) for moving a patient higher or lower limbs; at least an infrared light source (5) integral with said support (1), directed so to illuminate at least a muscle group moved by means of said arm (4); a data processing and control unit (6), configured to control said at least one light source (5) and said dynamometer (2), characterized in that said data processing and control unit (6) is configured to control an adjusting cycle of the intensity of said at least infrared light source (5) as a function of the movement cycle imposed by said dynamometer (2).

### BRIEF DESCRIPTION OF THE DRAWINGS

The device will be described in the following with reference to the appended FIGS. 1 and 2.

FIG. 1 shows a view of a preferred embodiment of a device according to the invention, shown while being used by a patient in FIG. 2.

### DETAILED DESCRIPTION OF THE INVENTION

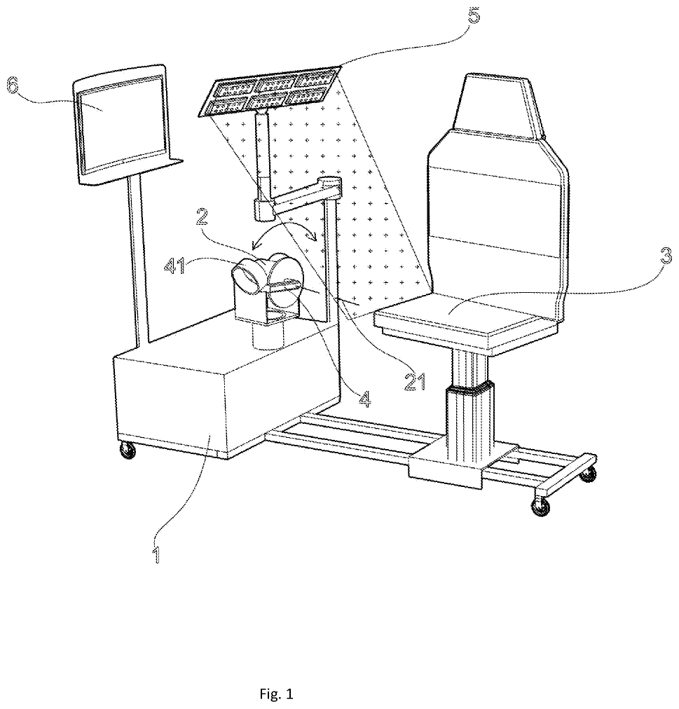

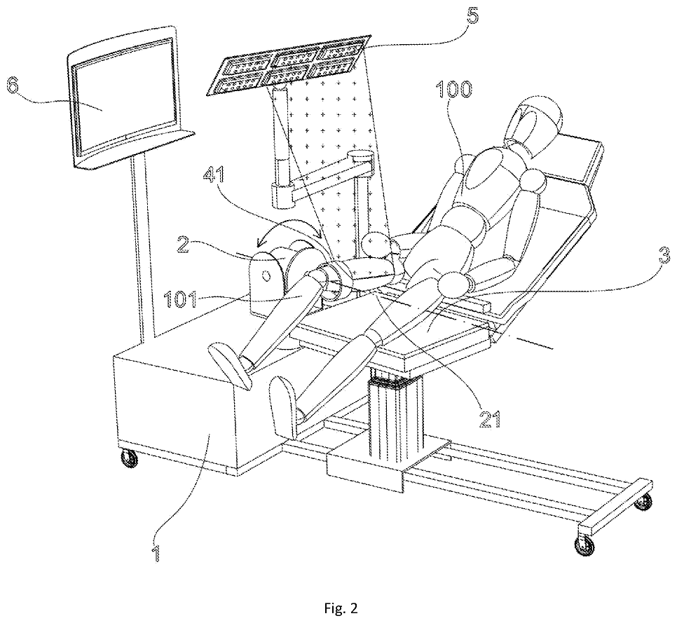

As it is shown in FIG. 1, the device comprises a support (1), on which at least a dynamometer (2) is installed, which is connected to an arm (4) provided with at least a gripping element (41) for moving a patient limb.

The device comprises also at least an infrared light source (5), and preferably a plurality of infrared light sources (5), arranged on a support integral with said support (1), directed to illuminate at least a muscle group moved by means of said arm (4), and a data processing and control unit (6), configured to control said at least one light source (5) and said dynamometer (2).

The device is characterized in that said data processing and control unit (6) is configured to control an adjusting cycle of the intensity of said at least one infrared light source (5) as a function of the movement cycle imposed by said dynamometer (2).

If there is a plurality of light sources (5), said data processing and control unit (6) is configured to adjust the intensity of the infrared radiation emitted in a differentiated way for each one of said sources.

It is also to be specified that in a first embodiment, the light intensity adjustment occurs by keeping the light source constantly on and by adjusting the emission power.

In a second embodiment, the light intensity adjustment occurs by keeping the emission power constant, but by switching on and off the light source according to the technique known as PWM, in which the adjustment occurs by varying the ratio between the switching on time and the switching off time (duty cycle).

In both cases, as a function of the movement cycle imposed by the dynamometer, and more in particular as a function of the force applied by the patient, as it will be better explained in the following, it is varied the whole irradiation intensity which arrives on the patient, regardless of how the light source adjustment occurs.

In another embodiment, the data processing and control unit is configured to switch on said light sources according to an on/off cycle in which the times of source on and source off are equal, and to vary the light intensity emitted and the switching on frequency as a function of the muscle effort exerted by the patient.

In this way, a visual stimulation (linked to the on/off frequency) is added to the thermal stimulation.

Said data processing and control unit comprises also a user interface, of the type known per se at the state of the art, which allows an operator to visualize the values of the machine operative parameters (such for example execution speed, applied force, constant of proportionality of infrared radiation, intensity of the radiation emitted by each light source) and to interact to provide to the processing unit the operative values of the exercise to be carried out. The user interface can be of any type known at the state of the art.

Moreover, on said processing and control unit (6) computer programs are stored, configured to implement the following method:
(1) subdividing the lower limbs in a plurality of areas, each one being associated to the stimulation by means of one of said infrared light sources (5);
(2) for each one of said areas defined at point 1, schematizing the action cycle imposed by the at least one dynamometer (2) as a sequence of a plurality of contraction and relaxation steps of the main muscle groups present in each area;
(3) determining, for each one of said light sources, an adjustment cycle of the intensity as a function of said contraction and relaxation cycle schematized at point 2) for the area associated to the specific light source.

The intensity adjustment cycle is configured so that each light source is switched on at the contraction steps of the respective muscle group and is switched off at the relaxation steps of the respective muscle group.

In order to maximize the proprioceptive stimulation each light source can be switched on with a defined time in advance with respect to the contraction step of the respective muscle group.

The dynamometer (2) is configured to measure the muscle effort exerted by each muscle group associated to each one of said areas defined at point 1, and said intensity adjustment cycle can be configured so that each one of said light sources
(5) is adjusted so that its intensity varies proportionally to the intensity of the effort exerted by the muscle group it is illuminating.

With reference to the FIG. 2, for example, the dynamometer (2) is configured to rotate around a horizontal axis (21), thus moving the leg (4) of the patient (100) by means of the arm (4). In other embodiments the rotation axis of the dynamometer can be inclined differently, according to the limb to be moved.

In other embodiments the gripping means (41) can be fastened to the distal portion of the lower limb, in order to allow the movement of the knee joint by contracting quadriceps.

In all these cases, the force exerted by the gripping means (41) can be opposite to the movement carried out by the patient or can help the movement of the user.

In particular, in case of exercises in which the dynamometer (2) assists the movement, i.e. the force exerted by the dynamometer and the muscle effort are directed in the same direction, said data processing and control unit is configured: to record during a first calibration cycle of the exercise in which the patient does not carry out any muscle effort and the movement is carried out at constant and predetermined speed, the force applied by said dynamometer (2) for the execution of the movement as a function of the position.

During this first cycle the patient is asked not to exert any effort, and so, the whole force needed to move the limb is applied by means of the dynamometer (2), and its development is recorded as a function of the position of the dynamometer, thus determining a correlation between the position of the limb and the force needed to carry out the movement. In the case shown in FIG. 2, for example, it is determined the relation between the force exerted by the dynamometer (2) and the angular position of the arm (4) with respect to the rotation axis (21).
to control, in the next execution cycles of the same movement the dynamometer so that the execution speed of the movement is the same speed as the first cycle, and to record the force exerted by the dynamometer (2) at each angular position.

During the next execution cycles, the patient is asked to exert the effort allowed by his health conditions. to adjust said light sources (5) so that, during each cycle and for each angular position, the intensity of the emitted infrared radiation is proportional to the difference of the force exerted by the dynamometer (2) during the first calibration cycle and the force exerted during the current cycle.

The constant of proportionality can be conveniently fixed by the operator, as well as the predetermined speed of execution of the movement.

In this way, the patient can have an infrared stimulation proportional to the effort exerted by him, even if such effort cannot be directly measured.

On the contrary, in case the dynamometer (2) is opposed to the movement, said data processing and control unit is configured:
to control said dynamometer (2) so that the speed of execution of the movement is constant and equal to a predetermined speed of execution, by adapting the force applied by the dynamometer so that it equals the force exerted by the patient; to adjust said light sources (5) so that the intensity of the emitted infrared radiation is proportional to the force exerted by the dynamometer (2).

The constant of proportionality can be conveniently fixed by the operator, as well as the speed of execution.

This synchrony between thermal stimuli and movement cycle amplifies the perception the user has of the movement he is carrying out and speeds up the rehabilitation process. Furthermore, mild heat makes the therapy more comfortable for the patient. Moreover, in order to guarantee the rehabilitation activity also in case of not collaboration of the patient, the arm (4) can be moved actively, by controlling the angular rotation of the shaft relative to the dynamometer (2) said arm (4) is connected to.

Moreover, yet to maximize the stimulation of the patient, a monitor visible by the patient can be installed on the base support (1), which monitor reproduces the movements of the patient by means of a webcam or in virtual reality.

In order to maximize the comfort of the rehabilitation session, a seat with reclinable back rest (3) provided with height and inclination adjustment systems can be arranged integrally with the base support (1), which seat can also come closer or move away from the arm (4), for example by means of a kinematic element made up of a guide.

1. An Isokinetic rehabilitation machine provided with light irradiating proprioceptive stimulation, comprising:
a support (1), on which at least a dynamometer (2) is installed, which is connected to an arm (4) provided with gripping elements (41) for moving a patient higher or lower limbs;
at least an infrared light source (5) integral with said support (1), directed so to illuminate at least a muscle group moved by means of said arm (4); a data processing and control unit (6), configured to control said at least one light source (5) and said dynamometer (2), wherein said data processing and control unit (6) is configured to control an adjusting cycle of the intensity of said at least one infrared light source (5) as a function of the movement cycle imposed by said dynamometer (2).

2. The Isokinetic machine according to claim 1, comprising a plurality of infrared light sources and characterized in that said data processing and control unit (6) is configured to control an adjusting cycle of the intensity in a differentiated way for each one of said sources.

3. The Isokinetic machine according to claim 1, further comprising a user interface which allows an operator to visualize the values of at least a machine functioning operative parameter and to interact to provide to said processing unit (6) at least an operative value relating to the machine functioning.

4. The Isokinetic machine according to claim 1, wherein said dynamometer (2) is configured to assist with its own force the movement exerted by the patient, and said data processing and control unit (6) is configured:
to record during a first calibration cycle of the exercise in which the patient does not carry out any muscle effort and the movement is carried out at constant and predetermined speed, the force applied by said dynamometer (2) for the execution of the movement as a function of the position of said arm (4);
to control, in the next execution cycles of the same movement, said dynamometer (2) so that the speed of execution of the movement is the same speed as the first cycle, and to record the force exerted by said dynamometer (2) at each position of said arm (4);
to adjust said light sources (5) so that, during each cycle and for each angular position, the intensity of the emitted infrared radiation is proportional to the difference of the force exerted by the dynamometer (2) during the first calibration cycle and the force exerted during the current cycle.

5. The Isokinetic machine according to claim 1, wherein dynamometer (2) is configured to be opposed with its own force to the movement carried out by the patient, and said data processing and control unit (6) is configured:
to control said dynamometer (2) so that the speed of execution of the movement is constant and equal to a predetermined speed of execution, by adapting the force applied by the dynamometer so that it equals the force exerted by the patient; to adjust said light sources (5) so that the intensity of the emitted infrared radiation is proportional to the force exerted by the dynamometer (2).

6. The Isokinetic rehabilitation machine provided with light irradiating proprioceptive stimulation, according to claim 1, wherein on said processing and control unit (6) computer programs are stored, configured to implement the following method:
(1) subdividing the lower limbs in a plurality of areas, each one being associated to the stimulation by means of one of said infrared light sources (5);
(2) for each one of said areas defined at point 1, schematizing the action cycle imposed by the at least one dynamometer (2) as a sequence of a plurality of contraction and relaxation steps of the main muscle groups present in each area;
(3) determining, for each one of said light sources, an adjustment cycle of the intensity as a function of said contraction and relaxation cycle schematized at point 2) for the area associated to the specific light source.

7. The Isokinetic rehabilitation machine provided with light irradiating proprioceptive stimulation, according to claim 5, wherein said intensity adjustment cycle is configured so that each light source is switched on at the contraction steps of the respective muscle group and is switched off at the relaxation steps of the respective muscle group.

8. The Isokinetic rehabilitation machine provided with light irradiating proprioceptive stimulation, according to claim 1, wherein each light source is switched on with a defined time in advance with respect to the contraction step of the respective muscle group.

9. The Isokinetic rehabilitation machine provided with light irradiating proprioceptive stimulation, according to claim 1, wherein the arm (4) can be moved actively.

10. The Isokinetic rehabilitation machine provided with light irradiating proprioceptive stimulation, according to claim 1, further comprising a monitor visible by the patient can be installed on said base support (1), which monitor reproduces the movements of the patient.

11. The Isokinetic rehabilitation machine provided with light irradiating proprioceptive stimulation, according to claim 1, further comprising a seat with reclinable back rest (3) integral with said base support (1).

12. The Isokinetic rehabilitation machine provided with light irradiating proprioceptive stimulation, according to claim 1, whenever a light intensity adjustment occurs by keeping the light source constantly on and by adjusting the emission power.

13. The Isokinetic rehabilitation machine provided with light irradiating proprioceptive stimulation, according to claim 1, wherein a light intensity adjustment occurs by keeping the emission power constant, and by switching on and off the light source by varying the ratio between the switching on time and the switching off time.

14. The Isokinetic rehabilitation machine provided with light irradiating proprioceptive stimulation, according to claim 1 wherein said data processing and control unit is configured to switch on said light sources according to an on/off cycle in which the times of source on and source off are equal, and to vary the light intensity emitted and the switching on frequency as a function of the muscle effort exerted by the patient.
